(19) United States
(12) Patent Application Publication
(10) Pub. No.: US 2006/0077191 A1
(43) Pub. Date: Apr. 13, 2006

(54) Non-rectangle display

(75) Inventors: Chen Ming-Daw, Hsinchu City (TW); Huang Jih-Fon, Zhubei City (TW)

Correspondence Address: BRUCE H. TROXELL, SUITE 1404, 5205 LEESBURG PIKE, FALLS CHURCH, VA, 22041, US

(73) Assignee: Industrial Technology Research Institute

(21) Appl. No.: 10/991,522

(22) Filed: Nov. 19, 2004

(30) Foreign Application Priority Data
Oct. 8, 2004 (TW) 93130472

(51) Int. Cl. G09G 5/00

(52) U.S. Cl. 345/204

(57) ABSTRACT

A non-rectangle display comprises a circuit substrate and a display panel connected to the circuit substrate. The circuit substrate has a driving device for driving the display panel to display video. The driving device includes at least one data line driver and at least one scan line driver. Each data line driver and each scan line driver are respectively disposed on at least one side of the display panel. The data line driver and the scan line driver are capable of operating cooperatively for driving the display panel. The display panel has a peripheral profile of at least one specific function curve.

### 1. FIELD OF THE INVENTION

The present invention relates to a display, and more particularly, to a display having a non-rectangle display panel.

### 2. BACKGROUND OF THE INVENTION

Nowadays, flat panel displays are widely used in various products such as computers, mobile phones, TVs, digital cameras, digital video cameras, watches, personal stereos, car/motorcycle instrument panels, signboards, and so on. However, shapes of conventional liquid crystal panels are always limited to be rectangular, which limits the use of such display. By virtue of this, the visual figure of a common video wall, which is made up of a plurality of rectangular displays, is also limited to be rectangular.

Referring to FIGS. 1A, 1B, 1C and 1D that if the display panel is nonrectangular, the use of such display panel will be widened and thus the economic value of the display panel is increased. For example, a display panel functioned as a mirror can be designed to be elliptic (now shown), a display panel 11 of a mobile phone 1 can be shaped as an octagonal display panel 12 (shown in FIG. 1A), a display panel 21 of a digital camera 2 can be shaped as a circular display panel 22 (shown in FIG. 1B), a car instrument panel 3 can be shaped as a semicircular display panel 31 (shown in FIG. 1C), and a traffic signboard 4 can be shaped as a triangular display panel 41 (shown in FIG. 1D).

Due to limitation of technology and material, the conventional display panel is inflexible and thus products employing such display panel are mostly in a simply rectangular shape. It is desired to design a non-rectangle display enabling a display wall to be combined by a plurality of non-rectangle displays for meeting the more versatile demands of the future while flexible display panel becoming popular.

### SUMMARY OF THE INVENTION

It is the primary object of the present invention to provide a non-rectangle display having a non-rectangle shaped display panel for meeting the demands of versatile usage.

It is another object of the present invention to provide a display wall composed of a plurality of non-rectangle displays, which is capable of enlarging video display by a specific means of signal transmission and distribution and functioning similar to a common TV wall.

To achieve the above objects, the present invention provides a non-rectangle display, comprising: a circuit substrate, and a display panel connected with the circuit substrate. The circuit substrate has a driving device for driving the display panel to display video. The driving device includes at least one data line driver and at least one scan line driver. Each data line driver and each scan line driver are respectively disposed at least one side of the display panel. The data line driver and the scan line driver cooperatively drive the display panel. The display panel has a peripheral profile of at least one specific function curve.

Other objects, advantages and novel features of the present invention will become apparent upon study of the remaining portions of the specification and drawings.

### BRIEF DESCRIPTION OF THE DRAWINGS

FIG. 1A is a schematic view showing a non-rectangle display of the present invention to be applied as a display of a mobile phone.

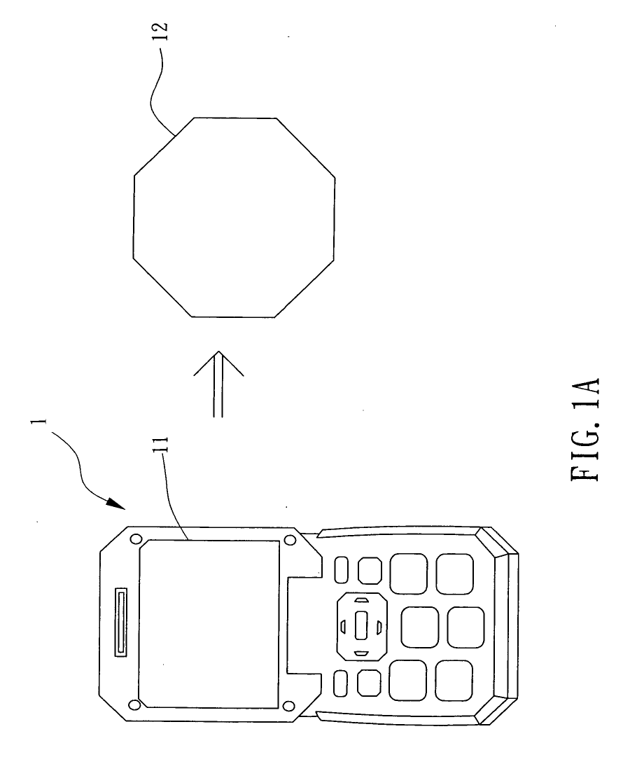

FIG. 1B is a schematic view showing a non-rectangle display of the present invention to be applied as a screen of a digital camera.

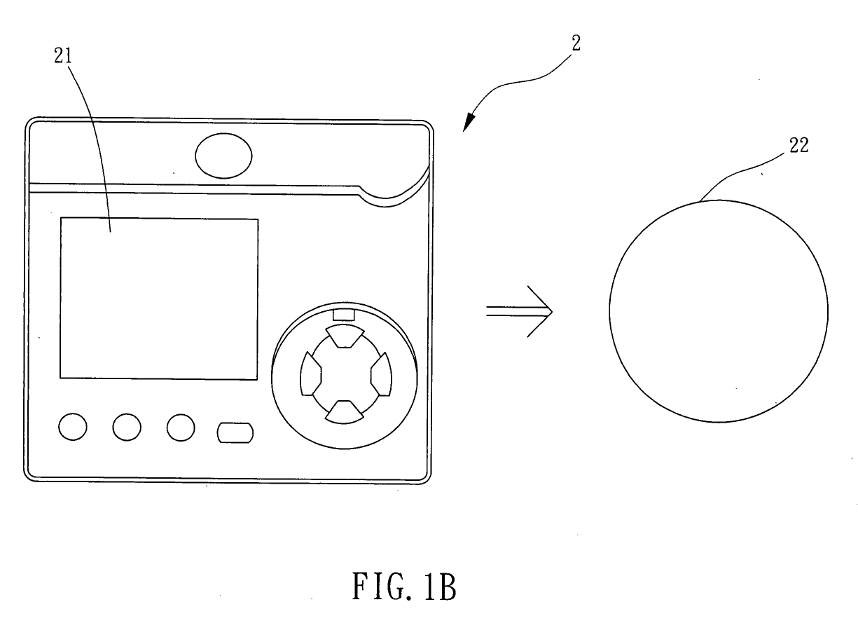

FIG. 1C is a schematic view showing a non-rectangle display of the present invention to be applied as an instrument panel of automobile.

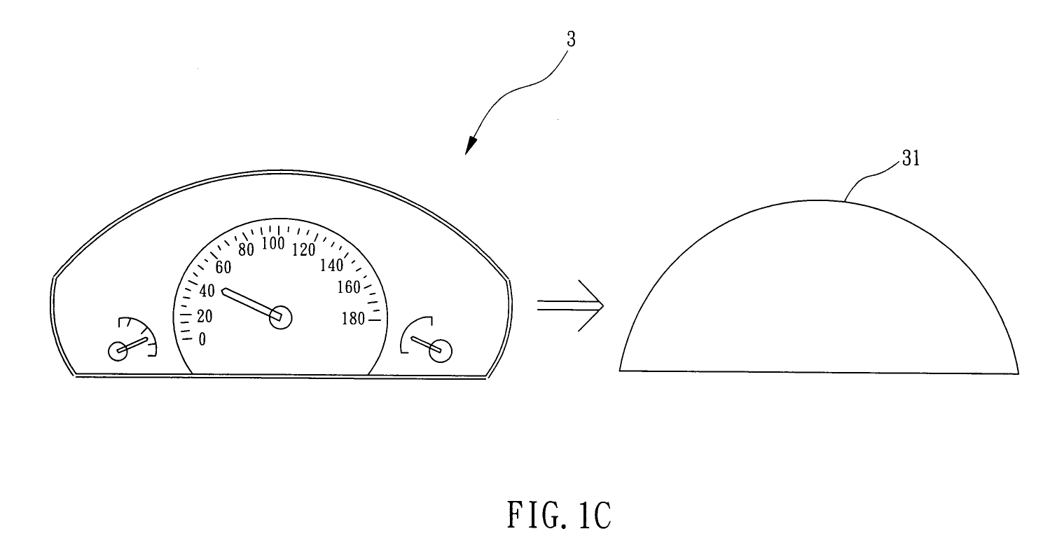

FIG. 1D is a schematic view showing a non-rectangle display of the present invention to be applied as a traffic signboard.

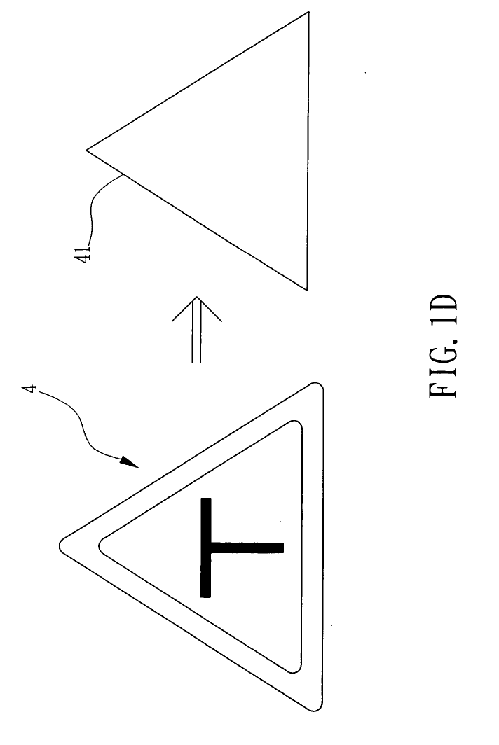

FIG. 2A is a schematic view showing a display panel of the non-rectangle display according to a preferred embodiment of the present invention.

FIG. 2B is a schematic view showing a display panel of the non-rectangle display according to another preferred embodiment of the present invention.

FIG. 2C is a schematic view showing a display panel of the non-rectangle display according to yet another preferred embodiment of the present invention.

FIG. 3 is a flow chart showing a fabricating process of a common LCD having a cutting step for forming a non-rectangle display of the present invention.

FIG. 4 is a top view of a non-rectangle display in accordance with an embodiment of the present invention.

FIG. 5 is a schematic view of a display wall composed of a plurality of non-rectangle displays of the present invention.

### DESCRIPTION OF THE PREFERRED EMBODIMENT

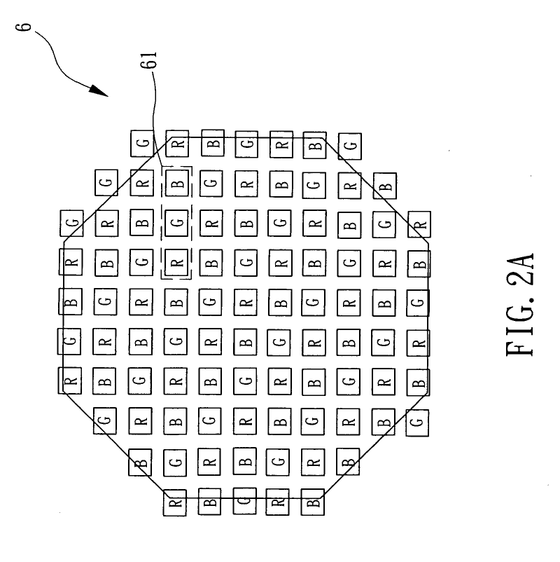

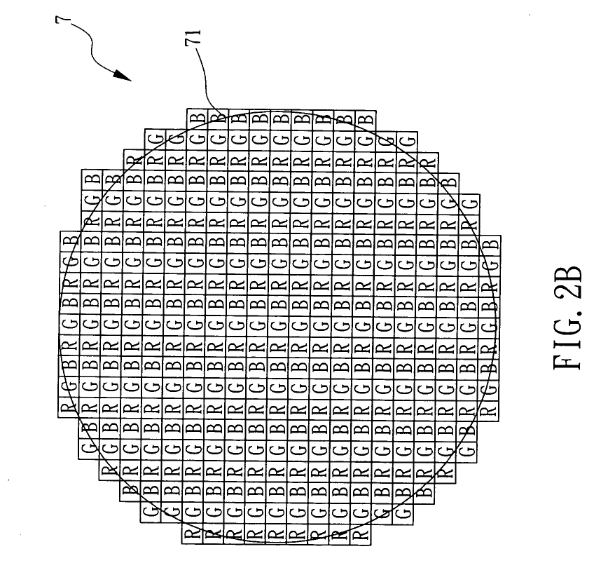

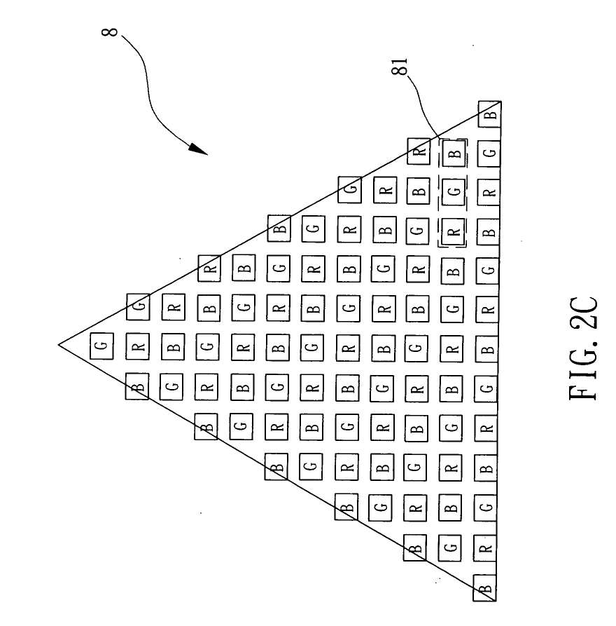

Referring to FIGS. 2A, 2B and 2C, which are schematic views of panels of non-rectangle displays with different shapes according to the present invention. As shown in FIG. 2A, an octagonal display panel 6 is pasted with a color filter (not shown), having a plurality of evenly arranged pixels 61, wherein each pixel 61 employs the red-green-blue (RGB) additive color system. As shown in FIG. 2B, a circular display panel 7 is pasted with a color filter (not shown), having a plurality of evenly arranged pixels 71, wherein each pixel 71 employs the red-green-blue (RGB) additive color system. As shown in FIG. 2C, a triangular display panel 8 is pasted with a color filter (not shown), having a plurality of evenly arranged pixels 81, wherein each pixel 71 employs the red-green-blue (RGB) additive color system. Currently a base panel fabricated by a common panel factory is simply a large piece of rectangular panel, which is already pasted with a color filter and has pixels evenly arranged therein.

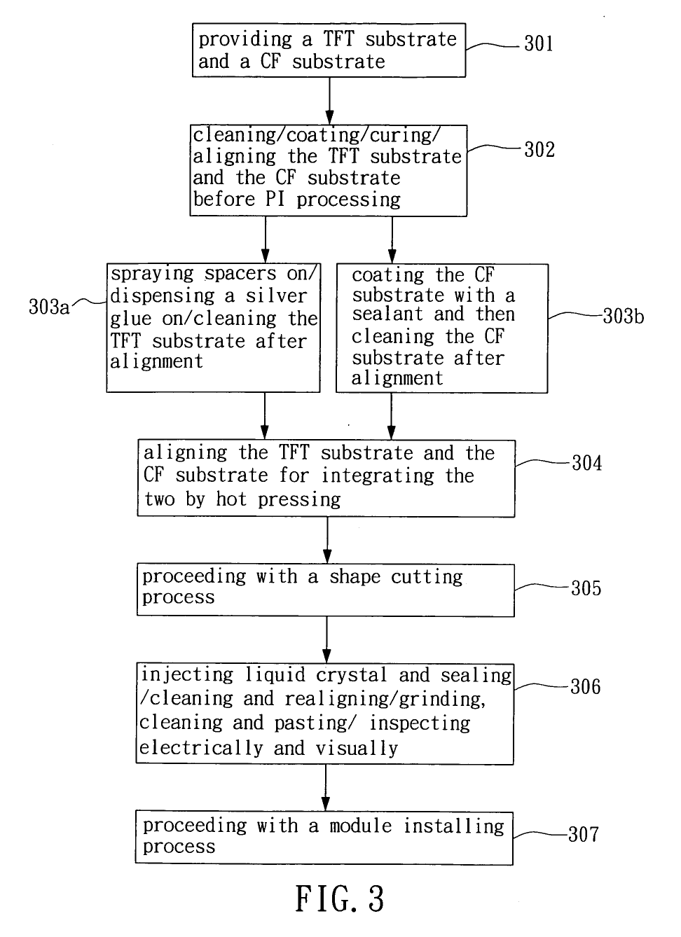

Referring to FIG. 3, a flow chart shows a fabricating process of a common LCD (liquid crystal display) a cutting step for forming a non-rectangle display of the present invention. The fabricating process 30 includes the steps of:
step 301: providing a thin film transistor (TFT) substrate and a color filter (CF) substrate;
step 302: cleaning/coating/curing/aligning the TFT substrate and the CF substrate before PI (polyimide) processing;
step 303a: spraying spacers on/dispensing a silver glue on/cleaning the TFT substrate after alignment;
step 303b: coating the CF substrate with a sealant and then cleaning the CF substrate after alignment;
step 304: aligning the TFT substrate and the CF substrate for integrating the two by hot pressing;
step 305: proceeding with a shape cutting process;
step 306: injecting liquid crystal and sealing/cleaning and realigning/grinding, cleaning and pasting/inspecting electrically and visually; and
step 307: proceeding with a module installing process.

In the present invention, the display panels can be cut in accordance with actual demands and so result in different shapes of display panels. The cutting process is generally processed at the posterior of cell processing, that is, after the process of aligning the TFT substrate (i.e. step 304) and the CF substrate for integrating the two by hot pressing and before the process of liquid crystal injection and seal (i.e. step 306). As to a glass substrate, the process of shape cutting can be processed using a laser or diamond blade. As to a plastic substrate, the process of shape cutting can be processed by a method of stamping.

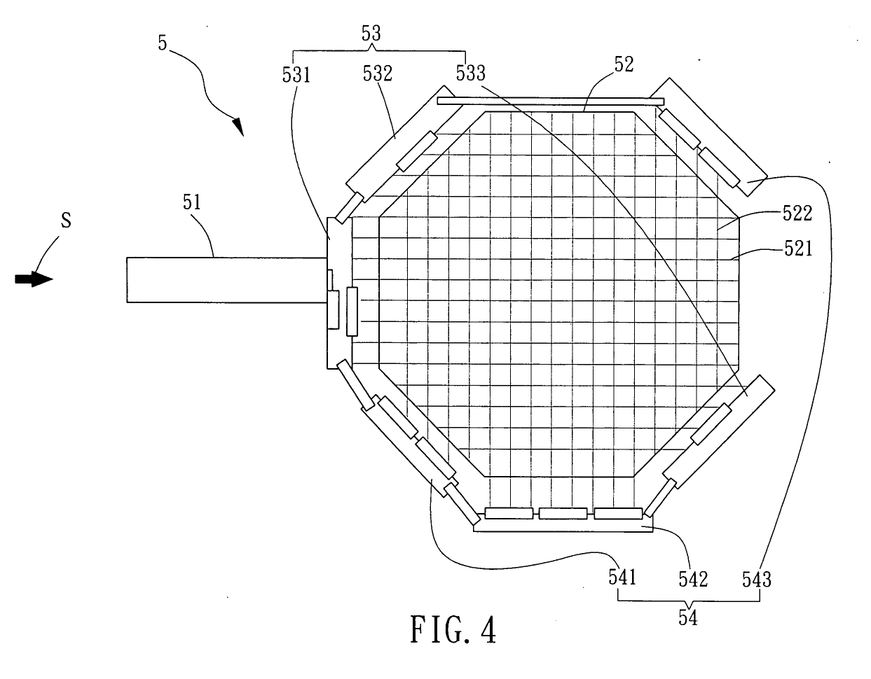

Referring to FIG. 4, a top plan view of a non-rectangle display in accordance with an embodiment of the present invention is shown. The non-rectangle display 5 includes a circuit substrate 51 and a display panel 52. The circuit substrate 51 has a scan line driver 53 and a data line driver 54, wherein the scan line driver 53 includes scan line ICs 531, 532, 533 configured at one side of the display panel 52, and the data line driver 54 includes data line ICs 541, 542, 543 configured at another side of the display panel 52. In this embodiment, the display panel 52 is an octagonal display panel. Of cause, the display panel 52 may be in any of other geometrical shapes except for rectangle.

As shown in FIG. 4, a plurality of horizontal lines 521 formed on the display panel 52 are scan lines and respectively connected with the scan line ICs 531, 532, 533, and a plurality of vertical lines 522 formed on the display panel 52 are data lines and respectively connected with the data line ICs 541, 542, 543.

In operation, a signal S is transmitted through the circuit substrate 51 to both the scan line driver 53 and the data line driver 54, such that the scan line driver 53 and the data line driver 54 are enabled for respectively driving the scan line ICs 531, 532, 533 and the data line ICs 541, 542, 543 to activate the horizontal lines 521 and the vertical lines 522 for start scanning respectively. In this regard, the display panel 52 is driven to display video through cooperative operation of the horizontal lines 521 and the vertical lines 522.

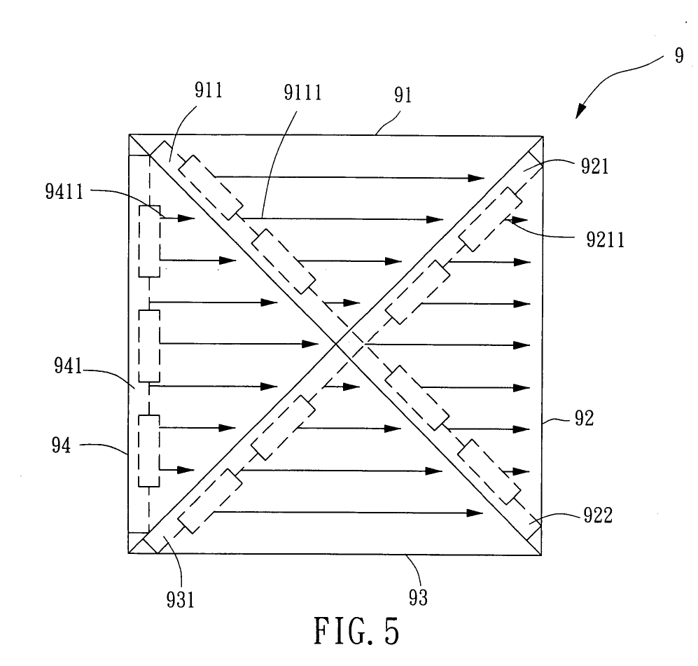

FIG. 5 is a schematic view of a display wall combined by a plurality of non-rectangle displays of the present invention. The display wall 9 is composed of four triangular displays 91, 92, 93, 94 of the same shape, wherein the triangular display 91 has a scan line driver 911 arranged at one side thereof; the triangular display 92 has scan line drivers 921, 922 respectively arranged at opposite sides thereof; the triangular display 93 has a scan line driver 931 arranged at one side thereof; and the triangular display 94 has a scan line driver 941 arranged at one side thereof.

When the display wall 9 is in operation while focusing only on the operation of the scan lines herein, the scanning order of the scan lines is described as follows. The scan line driver 941 firstly emits a horizontal scan line 9411. When the scan line 9411 is about to finish scanning, the scan line driver 911 subsequently emits another horizontal scan line 9111 at the same horizontal position. Then when the scan line 9111 is about to finish scanning, the scan line driver 921 subsequently emits another horizontal scan line 9211 at the same horizontal position. Therefore, the combined horizontal scanning operation of the scan line drivers 941, 911, 921 may be regarded as a continuous scanning operation. Similarly, display signal emission operation (not shown) of the vertical lines is also regarded as a continuous emission operation. Thus, the displayed videos of the triangular displays 91, 92, 93, 94, can match each other through the scan lines and the data lines to cooperatively drive the triangular displays 91, 92, 93, 94, that is, the display wall 9 can enlarge single video display thereby having an effect of a video wall.

However, the above-mentioned triangular display wall is only one embodiment of application of the non-rectangle display of the present invention for illustration but not limitation. A display wall combined by any quantity of the non-rectangle displays in any shapes should fall within the scope of the present invention as long as the scan line driver and the data line driver can cooperatively work.

In the embodiment of the present invention, the circuit substrate may be a flexible print circuit (FPC) with a circuit layout formed therein, or a chip on film (COF). In addition, the circuit layout may be directly formed at the display panel (e.g. glass) through a low temperature polysilicon (LTPS) process.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A non-rectangle display, comprising
a circuit substrate; and
a display panel, coupled to the circuit substrate;
wherein, the display panel has a peripheral profile of at least a specific function curve.

2. The non-rectangle display as claimed in claim 1, wherein the circuit substrate has a driving device for driving the display panel to display images.

3. The non-rectangle display as claimed in claim 2, wherein the driving device comprises at least one data line driver and at least one scan line driver, each data line driver and each scan line driver being respectively disposed on at least a side of the display panel, and the data line driver and the scan line driver capable of operating cooperatively for driving the display panel.

4. The non-rectangle display as claimed in claim 1, wherein the display panel has a driving device for driving the display panel to display images.

5. The non-rectangle display as claimed in claim 4, wherein the driving device comprises at least one data line driver and at least one scan line driver, each data line driver and each scan line driver being respectively disposed on at least one side of the display panel, and the data line driver and the scan line driver capable of operating cooperatively for driving the display panel.

6. The non-rectangle display as claimed in claim 1, wherein the circuit substrate has a first driving device, the display panel has a second driving device, and the first and second driving devices are capable of operating cooperatively for driving the display panel to display video.

7. The non-rectangle display as claimed in claim 6, wherein the first driving device comprises at least one data line driver, the second driving device comprises at least one scan line driver, each data line driver and each scan line driver are respectively disposed on at least one side of the display panel, and the data line driver and the scan line driver are capable of operating cooperatively for driving the display panel.

8. The non-rectangle display as claimed in claim 6, wherein the first driving device comprises at least one scan line driver, the second driving device comprises at least one data line driver, each data line driver and each scan line driver are respectively disposed on at least one side of the display panel, and the data line driver and the scan line driver are capable of operating cooperatively for driving the display panel.

9. The non-rectangle display as claimed in claim 1, wherein the circuit substrate is formed with a circuit layout.

10. The non-rectangle display as claimed in claim 1, wherein the display panel is formed with a circuit layout.

11. The non-rectangle display as claimed in claim 1, wherein the circuit substrate is a chip on film.

12. The non-rectangle display as claimed in claim 1, wherein the specific function curve is a continuous function curve.

13. The non-rectangle display as claimed in claim 1, wherein the specific function curve has two turning points between which first and second continuous functional curves are respectively connected.

14. The non-rectangle display as claimed in claim 1, wherein the specific function curve has three turning points.

15. The non-rectangle display as claimed in claim 1, wherein the specific function curve comprises: four turning points, being respectively a first turning point, a second turning point, a third turning point and a fourth turning point; and four subsidiary function curves, being respectively a first subsidiary function curve connecting the first turning point to the second turning point, a second subsidiary function curve connecting the second turning point the third function curve, a third subsidiary function curve connecting the third turning point to the fourth turning point, and a fourth subsidiary function curve connecting the fourth turning point to the first turning point; and at least two subsidiary function curves selected from the first, the second, the third, the fourth subsidiary function curve are not of the same length.

16. The non-rectangle display as claimed in claim 1, wherein the specific function curve comprises: four turning points, being respectively a first turning point, a second turning point, a third turning point and a fourth turning point; and four subsidiary function curves, being respectively a first subsidiary function curve connecting the first turning point to the second turning point, a second subsidiary function curve connecting the second turning point the third function curve, a third subsidiary function curve connecting the third turning point to the fourth turning point, and a fourth subsidiary function curve connecting the fourth turning point to the first turning point; and four included angles, being respectively a first included angle formed between the first function curve and the second function curve, a second included angle formed between the second function curve and the third function curve, a third included angle formed between the third function curve and the fourth function curve, a fourth included angle formed between the fourth function curve and the first function curve; and at least an included angle selected from first, the second, the third, the fourth included angle is not a right angle.

17. The non-rectangle display as claimed in claim 1, wherein the specific function curve has at least five turning points.
